(19) United States
(12) Patent Application Publication
(10) Pub. No.: US 2017/0372839 A1
(43) Pub. Date: Dec. 28, 2017

(54) CAPACITOR AND METHOD OF MAKING

(71) Applicant: EEStor, Inc., Cedar Park, TX (US)

(72) Inventor: Richard D. Weir, Cedar Park, TX (US)

(21) Appl. No.: 15/533,617

(22) PCT Filed: Dec. 7, 2015
(86) PCT No.: PCT/US15/64290

§ 371 Date: Jun. 6, 2017

Related U.S. Application Data
(60) Provisional application No. 62/089,198, filed on Dec. 8, 2014.
(60) Provisional application No. 62/094,766, filed on Dec. 19, 2014.

(51) Int. Cl. H01G 4/12; H01G 4/20; H01G 4/18

(52) U.S. Cl. CPC H01G 4/1227; H01G 4/18; H01G 4/206

(57) ABSTRACT

A capacitor can include a dielectric layer including a polymer matrix and ceramic particles dispersed with the polymer matrix. The polymer matrix can include epoxy. The ceramic powders can include composition modified barium titanate ceramic powders. In an embodiment, the capacitor can include a plurality of layers. In another embodiment, the dielectric layer can have a thickness of 0.1 microns to 100 microns.

### FIELD OF THE DISCLOSURE

The present invention relates in general to capacitors, in particular, to capacitors including dielectric layers including a polymer matrix and ceramic particles.

### RELATED ART

Electrolytic capacitors and supercapacitors are used to store small and larger amounts of energy, respectively, ceramic capacitors are often used in resonators, and parasitic capacitance occurs in circuits wherever the simple conductor-insulator-conductor structure is formed unintentionally by the configuration of the circuit layout.

Electrolytic capacitors use an aluminum or tantalum plate with an oxide dielectric layer. The second electrode is a liquid electrolyte, connected to the circuit by another foil plate. Electrolytic capacitors offer very high capacitance but suffer from poor tolerances, high instability, gradual loss of capacitance especially when subjected to heat, and high leakage current. Poor quality capacitors may leak electrolyte, which is harmful to printed circuit boards. The conductivity of the electrolyte drops at low temperatures, which increases equivalent series resistance. While widely used for power-supply conditioning, poor high-frequency characteristics make them unsuitable for many applications. Electrolytic capacitors will self-degrade if unused for a period (around a year), and when full power is applied may short circuit, permanently damaging the capacitor and usually blowing a fuse or causing failure of rectifier diodes (for instance, in older equipment, arcing in rectifier tubes). They can be restored before use (and damage) by gradually applying the operating voltage, often done on antique vacuum tube equipment over a period of 30 minutes by using a variable transformer to supply AC power. Unfortunately, the use of this technique may be less satisfactory for some solid state equipment, which may be damaged by operation below its normal power range, requiring that the power supply first be isolated from the consuming circuits. Such remedies may not be applicable to modern high-frequency power supplies as these produce full output voltage even with reduced input. Tantalum capacitors offer better frequency and temperature characteristics than aluminum, but higher dielectric absorption and leakage.

As indicated above the disadvantages of aluminum electrolytic capacitors are as follows:
Effective Series Resistance (ESR) has a large variation with temperature. A ten times variation can occur over the temperature range of −40° C. to 60° C.
Large Value Parasitic
   High ESR (Effective Series Resistance)
   High ESL (Effective Series Inductance)
Electrolytic capacitors eventually degrade with usage. Furthermore, the electrolytic eventually dries out which leads to failure
Long term storage will cause the aluminum oxide barrier to de-form.
   Capacitance will be significantly reduced.
   ESR increases which cause internal heating which leads to failure.
   This effect is worse at high temperatures within the operating parameters of the capacitor
A ceramic capacitor in parallel with the aluminum electrolytic capacitor is needed in switching mode applications to assist in reducing the apparent ESR and ESL to reduce the switching mode power supply failures.
Leakage current increases rapidly with increased heat.
Aluminum Electrolytic Capacitors will fail due to the following conditions:
   Excessive temperature
   High ripple current
   Shock
   Fast charge and discharge
   Reversed polarity
   Over voltage
   Long storage times
   AC signals

Further improvement in capacitor design is desired.

### BRIEF DESCRIPTION OF THE DRAWINGS

Embodiments are illustrated by way of example and are not limited in the accompanying figures.

FIG. 1 includes a scanning electron microscope (SEM) picture of a dielectric layer including a polymer matrix and coated composition-modified barium titanate ceramic particles at 8100 times magnification.

FIG. 2 includes a SEM picture of the dielectric layer including the polymer matrix and the coated composition-modified barium titanate ceramic particles at 335 times magnification.

FIG. 3 includes a diagram of a system to control capacitance and leakage current measurements.

FIG. 4 includes a diagram of the circuit of FIG. 3 with parasitic characteristics represented with parasitic circuit elements.

FIG. 5 includes a schematic illustrating a particular stacking process.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention. Also, for conceptual simplicity, some structures that are represented by a single circuit element may in fact correspond to multiple physical elements connected either in series, in parallel, or in some other series and parallel combination.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

Embodiments herein are drawn to a capacitor that includes a dielectric layer and further includes electrodes, wherein the dielectric layer can be disposed between the electrodes. The dielectric layer can include a polymer matrix and ceramic particles dispersed within the polymer matrix. The dielectric layer can have desirable thickness and uniform distribution of the ceramic particles. Other embodiments herein are drawn to a method of forming the capacitor including the dielectric layer. The dielectric layer can be thin and uniform, and formed such that air gaps and cracks may not form during the process of forming the layer. The capacitors fabricated by the methods of embodiments herein can have high voltage capability, low leakage current, and highly stable capacitance with voltage. The capacitor can also have excellent operating life, low insulation resistance, and extremely high voltage breakdown capability.

In accordance with an embodiment, the polymer matrix can include a polymer, or more than one polymer. The polymer can include poly(ethylene terephthalate) (PET), polycarbonate (PC), polypropylene (PP), polyethylene (PE), poly vinyl chloride (PVC), poly(vinylidenefluoride) (PVDF), poly(methyl methacrylate) (PMMA), polyvinyl alcohol (PVA), poly(ethylene napthalate) (PEN), poly(phenylenesulfate) (PPS), epoxy, or any other polymer with acceptable electrical characteristics. In a particular embodiment, the polymer can include an epoxy resin. The epoxy resin can include bisphenol A epoxy resin, aliphatic epoxy resin, aliphatic glycidylether modified bisphenol A epoxy resin, or a combination thereof. Examples of liquid epoxy resins are D.E.R.™ 317, D.E.R.™ 324, D.E.R.™ 325, D.E.R.™ 330, D.E.R.™ 331, D.E.R.™ 332, or D.E.R.™ 337 (The Dow Chemical Company, Midland, Mich.).

In certain embodiments, the polymer disclosed herein can be dissolved in an appropriate solvent to form a polymer precursor solution. Examples of solvents can include hexafluoroisopropanol (HFIP) or phenol for PET; pyridine for PC; N and N-dimethylformamide for PVDF. In accordance with another embodiment, the solvent can be selected in accordance with the desired viscosity of the polymer, such that for example, the viscosity can be adjusted according to the processes used to form the dielectric layer. For example, in spin coating, certain viscosity may be desired for achieving desirable thickness of the dielectric layer. Varying the ratio of the polymer to the solvent can change the viscosity. For example, increasing the amount of the solvent used to dissolve the polymer can help to reduce the viscosity, and using less solvent can increase the viscosity of the polymer. The vapor pressure of the solvent may also affect the viscosity. In accordance with yet another embodiment, a chemical constituent can be added to the polymer or polymer precursor solution to produce the desirable viscosity. Varying the ratio of the polymer to the chemical constituent can also adjust the viscosity. Examples of the chemical constituent for varying the polymer viscosity can include butyl glycidyl ether, aliphatic glycidyl ether, cresyl glycidyl ether, or ethylhexyl glycidyl ether. Still, in accordance with another embodiment, a curing agent can be added to the polymer precursor solution. The curing agent can include an amine, such as polyether diamine, an aliphatic polyether diamine, polyoxypropylenediamine, or the like. As used herein, the polymer precursor solution can be a mixture including a desirable polymer, a solvent, an appropriate chemical constituent, a curing agent as described herein, or any combination thereof.

According to at least one embodiment, the polymer matrix can include ceramic particles dispersed within the matrix. The ceramic particles can include a composition-modified barium titanate (CMBT). In a particular embodiment, the CMBT can have a formula (Ba_{1-α-μ-ν}A_{μ}D_{ν}Ca_{α})[Ti_{1-x-δ-μ′-ν′}Mn_{δ}A′_{μ′}D′_{ν′}Zrₓ]_{z}O₃, where A=Ag or La, A′=Dy, Er, Ho, Y, Yb, or Ga; D=Nd, Pr, Sm, or Gd; D′=Nb or Mo, 0.10≦x≦0.25; 0≦μ≦0.01, 0≦μ′≦0.01, 0≦ν≦0.01, 0≦ν′≦0.01, 0≦δ≦0.01, 0.995≦z≦1, and 0≦α≦0.005. In an even more particular embodiment, the CMBT can have the constituents listed in the following table 1.

TABLE 1

| Metal | | Atom | | | |
|---|---|---|---|---|---|
| element | | fraction | At Wt | Product | Wt % |
| Ba | | 0.9575 | 137.327 | 131.49060 | 98.52855 |
| Ca | | 0.0400 | 40.078 | 1.60312 | 1.20125 |
| Nd | | 0.0025 | 144.240 | 0.36060 | 0.27020 |
| | Total | 1.0000 | | | 100.00000 |
| Ti | | 0.8150 | 47.867 | 39.01161 | 69.92390 |
| Zr | | 0.1800 | 91.224 | 16.42032 | 29.43157 |
| Mn | | 0.0025 | 54.93085 | 0.13733 | 0.24614 |
| Y | | 0.0025 | 88.90585 | 0.22226 | 0.39839 |
| | Total | 1.0000 | | | 100.00000 |

In certain instances, lanthanum (La) and tin (Sn) can be used in the CMBT. The processes and materials that can be used to fabricate the CMBT powder can be found in each of U.S. Pat. No. 7,914,755 B2 by Richard D. Weir et al. and US2012/0212987 A1 by Richard D. Weir et al., both of which are incorporated herein in their entireties.

According to an embodiment, the CMBT powder can be coated with an organic material to promote dispersion in the polymer matrix. In a particular embodiment, the organic material can include an amphiphilic agent, such as a trialkoxysilane, where the alkyl group can include, such as 1 to 5 carbon atoms. In a particular embodiment, a thin layer of coating of a trialkoxysilane may be formed. Examples of the trialkoxysilane can include, but not limited to, amino propyl triethoxysilane, vinyl benzyl amino ethyl amino propyl trimethoxysilane, methacryloxypropyl trimethoxysilane, glycidoxypropyl trimethoxysilane, phenyl trimethoxysilane, or N-(2-aminoethyl)-3-aminopropyltrimethoxysilane. The amphiphilic agent can be chosen such that the organic group matches the polymer into which the ceramic particles are being dispersed. Alternatively, the trialkoxysilane functional group can be substituted with a phosphonic, sulfonic, or carbonic acid group.

In a very particular embodiment, the CMBT ceramic powder can be coated with an amphiphilic agent, such as a silane, as follows:
1. In a 250 mL beaker, combine 100% ethanol and distilled water in a ratio of 15:1 to 20:1, such as combining 154.4 mL of 100% ethanol with 8.125 mL of DI water.
2. Place the beaker on the hot plate with the mixer impeller blade in the solution.
3. Turn up speed dial as fast as possible without splashing or having the solution touch the top of the beaker.
4. Add 2 to 5 mL of silane solution, such as 3.25 mL.
5. Set the heat control around 190° C. to 225° C., such as 215° C. on the heating stand and ensure that this temperature maintains a solution at a desired temperature of 60° C. to 80° C., such as 70° C. Frequently check temperature with a thermocouple and adjust heat plate as desired.
6. Once the desired solution temperature is maintained, slowly add 50 g to 80 g, such as 65 g, of CMBT powder into the solution.
7. Allow the solution to remain at the desired solution temperature while mixing for 0.5 hours to 1.5 hours, such as 1 hour, or until approximately 2 cm to 4 cm, such as 2.5 cm liquid remains. Be careful not to cook or boil to complete dryness.
8. Place the powder like sludge into the vacuum oven at 100° C. to 140° C., such as 120° C., at 5 inches (12.5 cm) water column (WC) for 1 hour or until the silane is complete cured.
9. Break up the powder and distribute the silane evenly between 4 (50 mL) centrifuge tubes.
10. Add 35 mL to 45 mL, such as 40 mL, of ethanol to each tube. Ensure that each tube has approximately the same volume.
11. Shake the tubes vigorously.
12. Centrifuge the tubes for 10 minutes to 30 minutes, such as 20 minutes at 2.0 relative centrifuge force (rcf) to 5.0 rcf, such as 3 rcf.
13. Pour off the ethanol from the top.
14. Using a spatula or other similar tool to break up the solid at the bottom.
15. Add 35 mL to 45 mL, such as 40 mL, of ethanol to each tube. Ensure that each tube has approximately the same volume.
16. Shake the tubes vigorously.
17. Centrifuge the tubes for 10 minutes to 30 minutes, such as 20 minutes at 2.0 rcf to 5.0 rcf, such as 3 rcf.
18. Pour off the ethanol from the top.
19. Using a spatula or other similar tool to break up the solid at the bottom.
20. Place the solids in the vacuum oven overnight at 70° C. to 100° C., such as 90° C., with air flowing (such as 5 inches (12.5 cm) WC).
21. Pestle grind the powder and place back in the vacuum oven at 70° C. to 100° C., such as 90° C., with air flowing (such as 5 inches (12.5 cm) WC) daily until completely dry and ground into a fine powder (at least 3-4 days).

According to an embodiment, the coated CMBT powder can be dispersed into the polymer precursor solution through, for example, high turbulence mixing. The following is an example of high turbulent mixing, and epoxy is used as an exemplary polymer for illustration purpose. Other polymers of embodiments herein can be used to form a mixture with the coated CMBT powder. The high turbulent mixing system can be an ultrasonic unit or a unit that can apply turbulent vibrational mixing.
1. Place mixing container that is used by the high turbulent mixing system on a scale and then zero out on the scale; then weigh specified amount of the liquid epoxy resin into mixing container.
2. Place plastic weigh boat on scale and zero out the scale, and weigh a specified amount of composition-modified barium titanate powders to add to mixing container.
3. Use auto-pipette to add specified amount of constituent chemicals to the mixing container.
4. Hand mix solution then set intensity to 40% to 70%, such as 60%, on the high turbulent mixing system and mix for 10 min to 1 hour, such as 30 minutes.
5. Remove mixing container from high turbulent mixing system and remove cover to prepare for degassing. Set the degassing intensity to 5% to 20% (depending on viscosity, such as 12%) and degas for 45 min to 150 min, such as 105 minutes, at desired vacuum. Note: the degassing process is where the container is sealed and a vacuum is created to assist in removing the air bubbles from the polymer solution.

In an embodiment, the mixture including the polymer precursor solution and the ceramic particles can be formed into the dielectric layer. Different processes may be used to dispose a polymer dielectric layer on a substrate, such as screen printing process, tape or sheet casting methods, or spin coating. However, a polymer composite dielectric material including 20% or higher fill factors (such as ceramic particles), the screen printing process or the tape or sheet casting methods may require longer drying time and a non-uniform distribution of ceramic particles can occur.

A spin coating process can be used to form a polymer dielectric film by depositing a small puddle of a polymer resin fluid onto the center of a substrate, static or spinning at a low speed (e.g. not greater than 500 rpm), and then spinning the substrate at high speed (e.g. 3000 rpm). Centripetal acceleration can cause the resin to spread to, and eventually off, the edge of the substrate leaving a thin film of polymer resin on the surface. The nature of the resin (viscosity, drying rate, percent solids, surface tension, etc.) and the parameters chosen for the spin process can affect final film thickness and other properties of the dielectric film. Factors such as final rotational speed, acceleration, and fume exhaust contribute to the properties of coated film.

According to an embodiment, a spin coating process can be used to form the dielectric layer including the polymer matrix and the ceramic particles. The spin coating process can be controlled by carefully tuning the parameters of the process to form the dielectric film with desirable uniformity, thickness, and other properties. A subtle variation in the parameters of the spin coating process can result in drastic variations in the coated film. Certain effects of these variations are described in embodiments herein.

In an embodiment, the spin coating process can include dispensing. In the dispense action, a portion of the mixture of the polymer precursor and the ceramic particles can be deposited onto the substrate surface. The substrate can be held rigidly onto the spin coater. In an embodiment, the substrate can include flexible material, such as a metal foil. In another instance, the substrate can include a rigid material, such as a metal coated glass or solvent resistant plastic. In a further embodiment, the mixture can be injected onto the substrate. The amount of dispersion injected can be dependent on the substrate size and shape. In a particular embodiment, the minimum amount of the mixture needed to cover the substrate can be dispensed. Excess dispersion may be flung from the edges of the substrate during a subsequent action.

In accordance with an embodiment, dispense can include static dispense, dynamic dispense, or a combination thereof. According to an embodiment, static dispense can include depositing a portion of the mixture on or near the center of the substrate. The substrate can be static, such as having a spin speed of 0 rpm. The amount of the mixture dispensed can range from 1 to 10 cc or higher than 10 cc, depending on the viscosity of the mixture, the size of the substrate to be coated, or any of the forgoing. For example, a greater amount of the mixture may be dispensed onto a larger substrate or may be used for the mixture with higher viscosity, such that full coverage of the substrate during the spin action can occur.

In a particular embodiment, the spin coating process can include dynamic dispense. Dynamic dispense can include dispensing the mixture while the substrate is turning at a low speed. For instance, the speed can be in a range of 100 rpm to 500 rpm. Dynamic dispense may allow a smaller amount of the mixture, with respect to the static dispense process, to be used for full coverage of the substrate, because the initial low speed of the substrate may help to spread the mixture over the substrate and reduce the amount needed to wet the entire surface of the substrate. Dynamic dispense can result in less waste of the mixture including the polymer precursor solution and the ceramic particles. Dynamic dispense can also help to eliminate voids that may form when the mixture or substrate has poor wetting abilities.

According to one embodiment, the spin coating process can include a spin action. The spin can include acceleration, such that spin can be performed at a relatively high speed with respect to the spin speed of dynamic dispense. The spin speed can range from 1000 rpm to 6000 rpm, depending on the properties of the mixture as well as the substrate. For example, the spin speed can be in a range of 1500 rpm to 3500 rpm. In another embodiment, the spin speed can be higher than 3500 rpm. Varying the spin speed can change the final thickness of the dielectric layer. For example, spinning at a higher speed may help to reduce the thickness if a thinner film is desired. According to another embodiment, spinning can take from 10 seconds to several minutes, such as from 10 seconds to 5 minutes, depending on the properties of the mixture, desired thickness of the coated film, the properties of the substrate, or any combination of the forgoing.

In a particular embodiment, the spin action can include also a spin speed ramp-up profile, such that the spin action can have different speeds with each having different processing times. For example, the spin speed can be 1600 rpm to 3200 rpm for a certain period of time, and then change to not greater than 2500 rpm (e.g. 1200 rpm to 2000 rpm) for another period of time. In an instance, the first spin speed can last for less than 20 seconds, for example, 1 second to 18 seconds. The second spin speed can last for less than 2 minutes, such as 30 seconds to 2 minutes.

During the spinning action, the solvent if used can evaporate leaving a thin film including the polymer and CMBT ceramic particles that is being stretched by the angular motion. The combination of spin speed and time selected for the spinning action can help to control the final thickness of the dielectric layer. For example, increase the spin speeds and spin times can help to produce thinner dielectric layers.

Among various parameters of the spin coating process, spin speed can be an important factor. The speed of the substrate (rpm) can affect the degree of radial (centrifugal) force applied to the liquid resin as well as the velocity and characteristic turbulence of the air immediately above it. To some extent, the speed of the spin process may determine the final thickness of the dielectric layer. In a particular embodiment, the thickness of the dielectric layer can be changed by varying the spin speed. For example, a variation of ±50 rpm can cause a resulting thickness change of 10%. Film thickness can also be a balance between the force applied to shear the fluid resin towards the edge of the substrate and the drying rate which affects the viscosity of the resin. As the resin dries, the viscosity increases until the radial force of the spin process can no longer appreciably move the resin over the surface. At this point, the thickness may not decrease significantly with increased spin time. The acceleration of the substrate towards the final spin speed can also affect properties of the coated dielectric film and it may be desired to accurately control acceleration to allow the film to have linear expansion during the initial spin process.

The spin process can provide a radial (outward) force to the liquid resin, and acceleration can provide a twisting force to the resin. This twisting aids in the dispersal of the mixture around topography that might otherwise shadow portions of the substrate from the fluid. Acceleration of spinners is programmable with a resolution of 1 rpm/second. In operation the spin motor can accelerate (or decelerate) in a linear ramp to the final spin speed. It may also be important that the airflow and associated turbulence above the substrate itself be minimized, or at least held constant, during the spin process.

In yet another embodiment, the spin coating process can include drying to eliminate excess solvents from the resulting dielectric layer. The drying action can be performed after spinning, which may help to further dry the dielectric layer without substantially reducing the thickness of the layer. This can be advantageous for thick dielectric layers since long drying times may be necessary to increase the physical stability of the layer before handling. Without the drying step, problems may occur during handling, for example, the layer may pour off the side of the substrate when being removed from the spin bowl. In another embodiment, a moderate spin speed, such as 25% of the speed used for high speed spin, may be used to aid in drying the layer without significantly changing the thickness of the layer.

In accordance with an embodiment, the spin coating process can include curing. Curing may be performed after the spinning action to completely remove the remaining solvent to cure the mixture. In an instance, curing may be performed in lieu of drying, particularly when the mixture includes the chemical constituent disclosed herein. The curing action can include curing in vacuum, in an oven, or in vacuum oven. Curing time, curing temperature, and level of vacuum process can affect curing of the mixture including the polymer precursor solution and the ceramic particles and can be chosen based on the properties of the polymer.

As disclosed herein, the thickness of the dielectric layer can be adjusted by changing one or any combination of the parameters disclosed herein. In an embodiment, the thickness of the dielectric layer can be at least 0.1 μm, such that sufficient insulation can be provided to adjacent electrodes. For example, the thickness of the dielectric layer can be at least 0.15 μm, at least 0.28 μm, or even higher. The thickness can be changed depending on the desirable properties of the capacitor. In an example, the thickness can be at least 0.6 μm, at least 1 μm, at least 3 μm, or at least 7 μm. In other embodiments, thickness may be not greater than 100 μm, as thinner dielectric layer may increase capacitance of the capacitor due to inverse relation between the thickness of the dielectric layer and the capacitance. For instance, the thickness of the dielectric layers may not be greater than 90 μm, 80 μm, or 70 μm. In a particular embodiment, the thickness of the dielectric layer may not be even greater than 50 μm. The thickness of the dielectric layer can be in a range including any of the minimum to maximum values noted above. For example, the thickness can be in a range of 0.1 μm to 100 μm, 0.28 μm to 90 μm, or 0.6 μm to 80 μm. In a particular embodiment, the thickness can be in a range of 3 μm to 50 μm. In an even more particular embodiment, the thickness can be in a range of 3 μm to 16 μm.

In accordance with one embodiment, the dielectric layer can have certain dielectric strength. For example, the dielectric strengths can be at least 30 V/μm, at least 40 V/μm, at least 45 V/μm, or 50 V/μm. In another embodiment, the dielectric strength may not be greater than 100 V/μm, such as not greater than 95 V/μm, not greater than 91 V/μm, or not greater than 85 V/μm. The dielectric strength can be within any of the minimum values to maximum values noted above, such as 30 V/μm to 100 V/μm. In a particular embodiment, the dielectric strength can be in a range of 40 V/μm to 85 V/μm.

According to another embodiment, the dielectric layer can have a desirable permittivity relative to permittivity of vacuum. For example, the relative permittivity of the dielectric layer can be at least 30, at least 50, at least 70, or even at least 110, at least 500, at least 1100, at least 2000, or at least 3000. The higher values of relative permittivity, such as 500 and higher, may be achieved by using a relatively more polar polymer, such as a relatively more polar epoxy. In another embodiment, the relative permittivity may be no greater than 10,000, no greater than 5000, no greater than 2000, no greater than 900, or no greater than 500. In a particular embodiment, the relative permittivity can be in a range of 30 to 1100 or 50 to 500.

After reading this disclosure, a skilled artisan would understand that single dielectric layers formed in accordance with the spin coating process can be combined and used to create a multilayer capacitor. For example, the layers can be stacked on top of each other, and the spin coating process can be repeated until the desired number of layers has been formed to produce the desired capacitance. In an embodiment, the capacitor can include a plurality of dielectric layers having thickness in a range of 3 μm to 100 μm and having dielectric strengths greater than 40 V/μm.

The features of the capacitors include a solid state polymer based capacitor where there is no liquid electrolyte, the energy is stored in the dielectric field, and no charging current flows through the capacitor. The CMBT powders are produced where the relative permittivity (capacitance) increases with applied voltage. The capacitor is sealed into to a plastic that is hydrophobic and therefore no degradation due to moisture. The plastic seal provides excellent resistance to shock and vibration. Furthermore, high insulation resistance is provided by the CMBT powder. When used, a coating is applied to the powders to assist in providing a seal that does not allow any degradation, extremely low leakage current. Still further, low product cost due to the low cost of the constituents and production equipment can allow for cost-effective manufacturing. The capacitor can include a large number of layers in a stack and provides a high capacitance with high voltage and resistance.

A capacitor as described herein can be used to a conventional aluminum electrolytic capacitor that fails to meet all of the features as seen with the novel capacitor. The capacitor is well suited for high voltage applications, such as the utility grid power factor correction market due to the small size, long operational life, and cost. The capacitor dielectric can have a relative permittivity of about 50. The most popular capacitor now used for the utility grid power factor correction is made of thin sheets of polypropylene (10 microns) rolled up with thin sheets of metal foil. The relative permittivity of polypropylene is 2.5, which is 5%, or potentially even less, than the relative permittivity for a capacitor as described herein. Furthermore, the same capacitors used in the utility grid power factor correction market are also used in the photovoltaic voltage smoothing market. Accordingly, capacitors as described herein can be useful in a variety of electrical utility based applications.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

### Embodiment 1

A capacitor comprising:
a first electrode;
a dielectric layer comprising:
a polymer matrix including epoxy; and
ceramic particles dispersed within the polymer matrix and comprising a composition modified barium titanate, and
a second electrode,
wherein the dielectric layer is disposed between the first electrode and the second electrode.

### Embodiment 2

The capacitor of Embodiment 1, wherein the modified barium titanate comprises a formula of (Ba_{1-α-μ-ν}A_{μ}D_{ν}Ca_{α})[Ti_{1-x-δ-μ′-ν′}Mn_{δ}A′_{μ′}D′_{ν′}Zrₓ]_{z}O₃, wherein A=Ag or La, A′=Dy, Er, Ho, Y, Yb, or Ga; D=Nd, Pr, Sm, or Gd; D′=Nb or Mo, 0.10≦x≦0.25; 0≦μ≦0.01, 0≦μ′≦0.01, 0≦ν≦0.01, 0≦ν′≦0.01, 0≦δ≦0.01, 0.995≦z≦1, and 0≦α≦0.005.

### Embodiment 3

The capacitor of Embodiment 1, wherein the ceramic particle is coated with an amphiphilic agent.

### Embodiment 4

The capacitor of Embodiment 1, wherein the dielectric layer has a thickness in a range of 0.1 microns to 100 microns.

### Embodiment 5

The capacitor of Embodiment 1, wherein the dielectric layer has a relative permittivity of at least 30.

### Embodiment 6

A capacitor comprising:
at least one dielectric layer comprising a polymer matrix and ceramic particles dispersed within the polymer matrix, wherein the polymer comprises epoxy;
wherein the dielectric layer has a relative permittivity of at least 30.

### Embodiment 7

The capacitor of Embodiment 6, wherein the dielectric layer comprises a thickness in a range of 0.1 microns to 100 microns.

### Embodiment 8

The capacitor of Embodiment 6, wherein the dielectric layer comprises a thickness in a range of 3 microns to 30 microns.

### Embodiment 9

The capacitor of Embodiment 6, wherein the ceramic particles make up at least 20 vol %, at least 30 vol %, at least 40 vol %, or at least 50 vol % of a total volume of the polymer matrix and the ceramic particles.

### Embodiment 10

The capacitor of Embodiment 6, wherein the ceramic particles make up not greater than 95 vol %, no greater than 90 vol %, or no greater than 85 vol % of a total volume of the ceramic particles and the polymer matrix.

### Embodiment 11

The capacitor of Embodiment 6, wherein the ceramic particles make up in a range of 20 vol % to 95 vol %, in a range of 30 vol % to 90 vol %, or in a range of 40 vol % to 85 vol % of a total volume of the ceramic particles and the polymer matrix.

### Embodiment 12

The capacitor of Embodiment 6, wherein the relative permittivity in a range of 50, at least 70, or even at least 110, at least 500, at least 1100, at least 2000, or at least 3000.

### Embodiment 13

A method of forming a capacitor on a substrate comprising:
providing a mixture including a polymer precursor solution and ceramic particles, wherein a volume percent of the ceramic particles for a total volume of the polymer solution and ceramic particles is at least 20%; and
spin coating the mixture to form the dielectric layer on the substrate.

### Embodiment 14

The method of Embodiment 13, wherein the polymer precursor solution comprises epoxy.

### Embodiment 15

The method of Embodiment 13 further comprising curing the mixture to form a dielectric layer.

### Embodiment 16

The method of Embodiment 15, wherein curing comprises curing the mixture at a temperature in a range of 70° C. to 140° C.

### Embodiment 17

The method of Embodiment 13, wherein spin coating comprises dispensing the mixture on the substrate spinning at a speed in a range of 0 rpm to 500 rpm.

### Embodiment 18

The method of Embodiment 17, wherein spin coating further comprises spinning at a speed in a range of 1000 rpm to 6000 rpm after dispensing.

### Embodiment 19

The method of Embodiment 13, wherein the dielectric layer has a thickness in a range of 0.1 microns to 100 microns.

### Embodiment 20

The method of Embodiment 13, wherein the dielectric layer has a relative permittivity of at least 30, at least 50, at least 70, or even at least 110, at least 500, at least 1100, at least 2000, or at least 3000.

### Example

The Example is given by way of illustration only and does not limit the scope of the present invention as defined in the appended claims. The Example demonstrates the formation of a capacitor including a dielectric layer in accordance with an illustrative, non-limiting embodiment.

A particular spin coating process is described as follows. After reading this disclosure, a skilled artisan would understand variation of the parameters of the spin coating process disclosed herein can be used to achieve certain properties of the dielectric layer and such modifications are within the scope of embodiments herein.
Mixture including 50% to 80% by volume CMBT, such as 70% by volume, and 20% to 50%, such as 30%, by volume polymer precursor solution was spin coated onto a 10 μm smooth copper film (the thickness and the material of the substrate can be changed as desired).
The spin profile was 100 rpm to 300 rpm, such as 200 rpm, for 3 to 10 seconds, such as 6 seconds, during which the solution was injected at a pressure of 10 PSI to 20 PSI, such as 13 PSI, for an initial spin time of 1 to 5 seconds, such as 3 seconds.
At the end of the initial spin time, a back vacuum was applied to the solution dispenser to assist in keeping any drops to be formed during the next spin speed profile.
Spin speed was then taken to 2200 rpm to 3000 rpm, such as 2800 rpm, for 1 to 8 seconds, such as 3 seconds.
Then the spin speed was decreased to 1000 rpm to 2000 rpm, such as 1500 rpm, and ran for 0.5 minutes to 2 minutes, such as 1 minute.
The layer was then removed from the spin coater and taken to the vacuum oven for final curing.
The layer was processed in the vacuum oven for the following temperature/vacuum cycle.
   70° C. to 90° C., such as 80° C., for 30 minutes to 90 minutes, such as 60 minutes.
100° C. to 140° C., such as 125° C., for 2 to 5 hours, such as 3 hours.

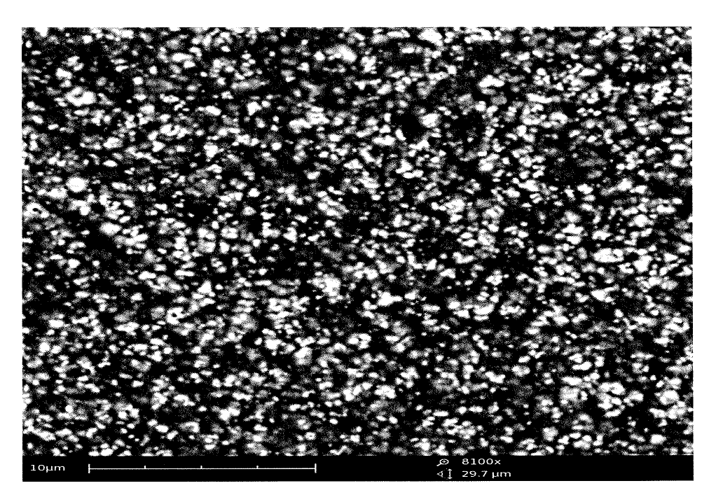

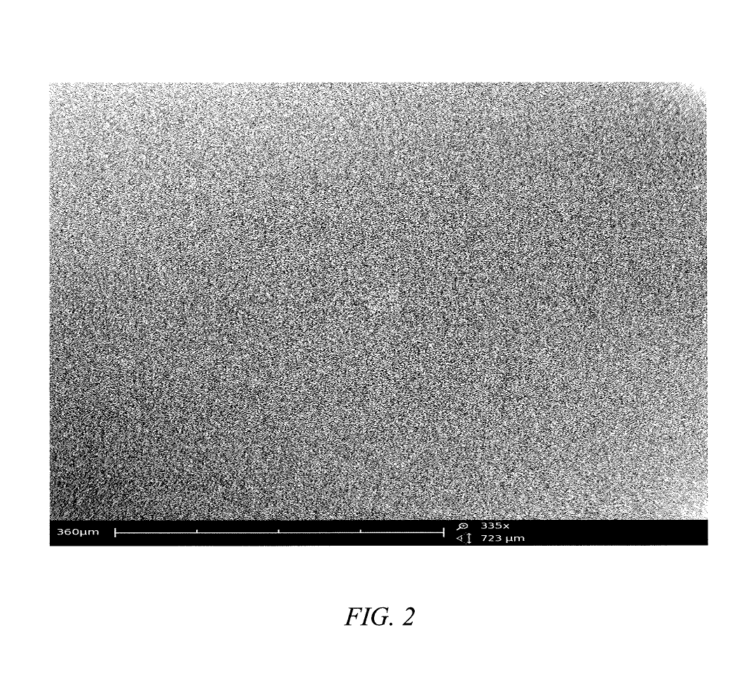

FIGS. 1 and 2 include SEM images of dielectric films formed in accordance with embodiments herein. The images indicate that both of the spin coated dielectric film were a contiguous smooth film without any flaws or breaks. The dielectric film shown in the images had a thickness of 10 microns.

FIG. 1 includes a SEM picture with 8100 times magnification. The dielectric layer included the polymer matrix and the coated CMBT ceramic particles.

FIG. 2 includes a SEM picture with 335 times magnification. The dielectric layer included the polymer matrix and the coated CMBT ceramic particles.

The formed dielectric layer was then tested on the capacitance vs. voltage test systems. The capacitance vs. voltage test system is indicated in the following schematic. The capacitor indicated on the schematic is the dielectric layer being tested.

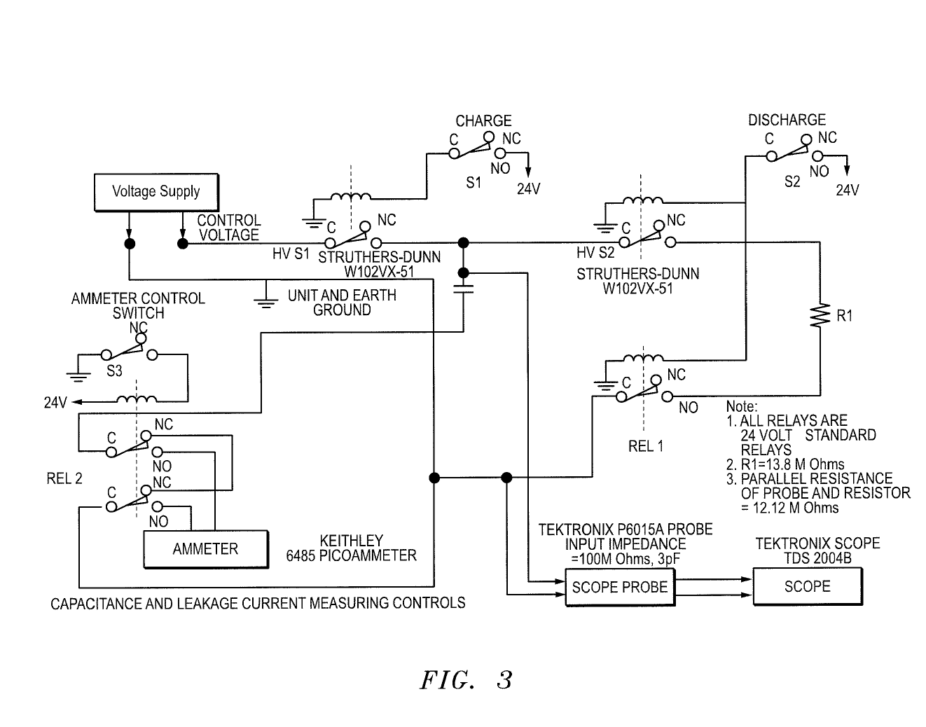

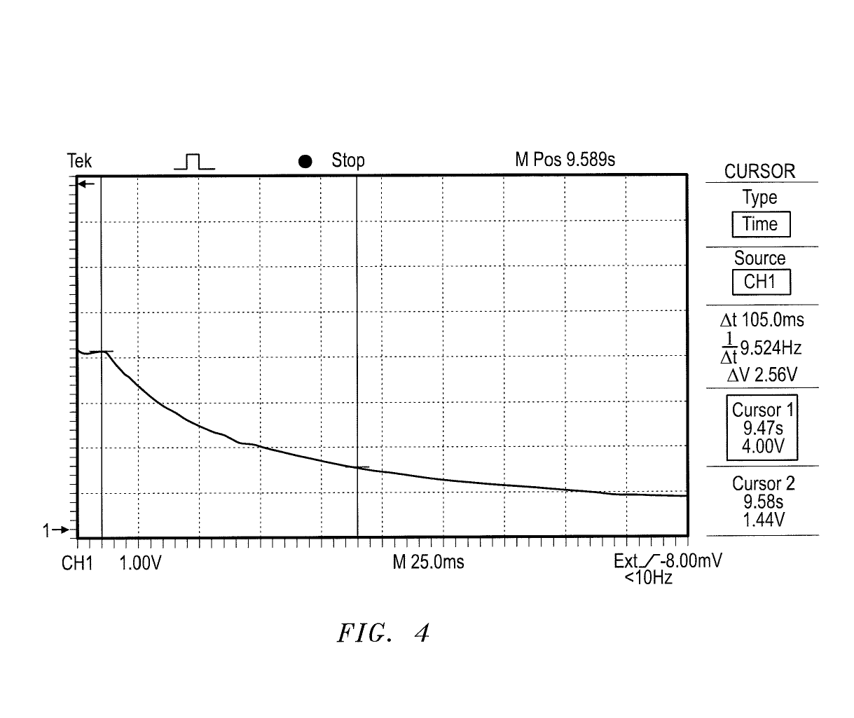

First the layer was installed into the test gig that connects the anode and cathode as indicated in the schematic in FIG. 3. The Stanford Research programmable power supply was increased to the desired voltage of 390V dc. Then R1 was switched to the active mode. Then the Stanford Research power supply is switched off and the decay voltage was captured onto the Tektronix scope, as illustrated in FIG. 4.

The vertical lines provide voltages of the discharge voltages at specific times. The initial vertical line indicates the initial voltage before the discharge has started, which is 4.0 volts dc. The discharge curve is created by the discharge resistor and the system resistance at that is 12.12×10⁶ ohms. The equation of RC=one discharge time constant is then used to calculate the capacitance therefore the capacitance is the one discharge time constant divided by the resistance. One time constant is 0.37 times the 4.0 volts, which is 1.48 volts. The second vertical line was set at 1.4 volts, which was the closest to the 1.48 volts that was available and the time at this setting was 105 milli seconds. This then provides a capacitance of this layer of 9 nano amps.

The size of the dielectric layer was 14.1 microns thick and in a shape of a one inch (2.5 cm) diameter circle. The leakage current was 36 nano amps and therefore the insulation resistance is that leakage current divided into the applied voltage of 390 V. Therefore the insulation resistance was 10.8 gaga ohms.

Particular embodiments herein are related to capacitor including a plurality of layers. The capacitor can include more than one layer of the dielectric films. Each of the dielectric layers can have the thickness disclosed herein, for example, in a range of 3 μm to 100 μm.

The capacitor can include more than one conductive layer. The conductive layer can include a metal, such as iron, nickel, chromium, aluminum, or a combination thereof. In another embodiment, other metal materials can be used for forming the conductive layer. In a particular embodiment, the conductive layer can include an alloy including the more than one metal disclosed herein. For example, the conductive layer can include stainless steel. In another particular embodiment, the capacitor can include at least one layer including a noble metal. Examples of the noble metal can include ruthenium, rhodium, palladium, silver, osmium, iridium, gold, or platinum. For instance, the capacitor can include at least one layer including gold.

The dielectric layers can be disposed between the conductive layers. In a particular embodiment, the layer including the noble metal, such as the gold layer, can act as a floating node of the capacitor. According to another embodiment, the gold layer can be formed by a sputtering process.

According to an embodiment, the conductive layer can have a thickness in a range of 5 μm to 20 μm, such as 7 μm to 18 μm or 9 μm to 15 μm.

According to another embodiment, the dielectric layers, conductive layers, and noble metal layers can be stacked in a mode, such that they are in a parallel mode where the capacitance of each layer is additive to the number of the layers in the stack. For example, if there are 1000 layers in the stack and the capacitance of each layer is 10 nano farads, then the capacitance of the stack would be 10 micro farads or 1000 time the capacitance of each layer.

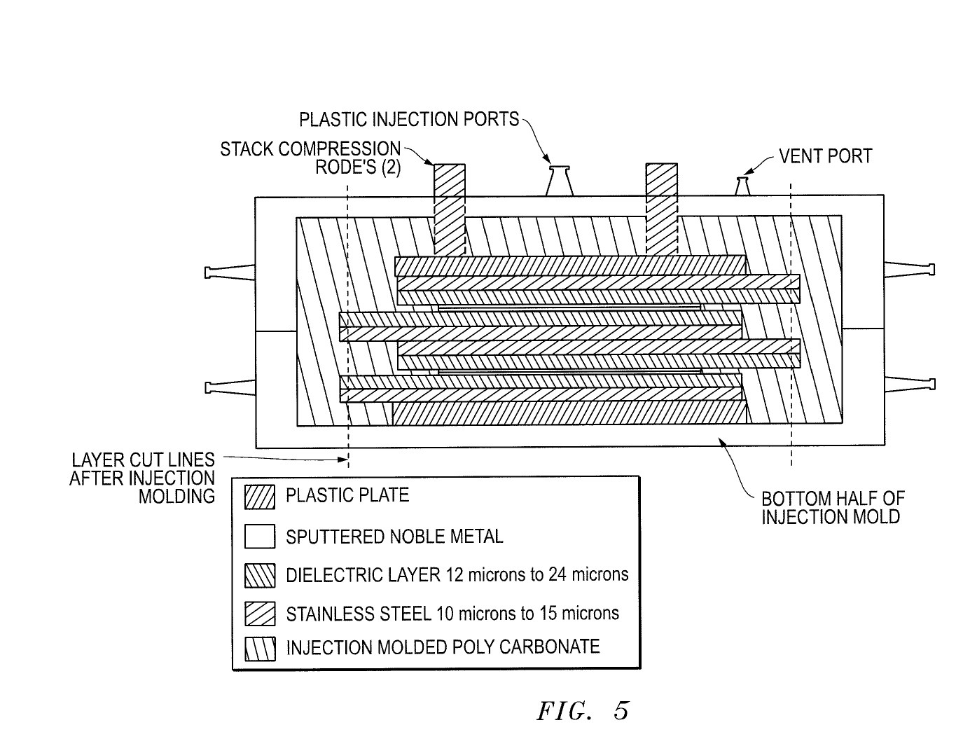

FIG. 5 includes a schematic illustrating a particular stacking process.

Referring to FIG. 5, the plastic injection ports allow melted plastic to be injected to the sides of the square layer, such that that all areas are filled with the plastic. The selected plastic can have dielectric field strength of 600 V/micron. When the applied voltage is 1,500 V and the distance between the positive and negative section of the internal layers is as close as 10 microns, the plastic can provide a protection of 6000 V. The stainless steel films can be, for example, 12.7 microns, which can provide sufficient stiffness to not bend when the melted plastic is injected. After the layers are injected molded, two of the sides will be water jet cut on the layer cut line to expose the plus and minus contacts of the capacitor. Then aluminum end sections will be glued onto the ends with silver filled epoxy adhesive.

The capacitors of the embodiments herein can be a solid state polymer based capacitor, where there is no liquid electrolyte. The energy can be stored in the dielectric field, where no charging current flows through the capacitor.

The capacitor can be sealed into a plastic that is hydrophobic to prevent degradation due to moisture. The plastic seal can also provide excellent resistance to shock and vibration. The capacitor with the large number of layers in the stack will have high capacitance with high voltage and resistance. The capacitor can be used in applications of aluminum electrolytic capacitors, utility grid power factor correction, and photovoltaic voltage smoothing.

The process disclosed herein incorporates the ceramic particles into the polymer matrix, other than using pure ceramic for forming the dielectric layer may help to increase the dielectric strength of the capacitor while maintaining a high dielectric constant. The CMBT powders can provide high insulation resistance and are produced where the relative permittivity (capacitance) increases with applied voltage. The coating that is applied to the CMBT powders can assist in providing a seal that helps to prevent degradation.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A capacitor comprising:
a first electrode;
a dielectric layer comprising:
a polymer matrix including epoxy; and
ceramic particles dispersed within the polymer matrix and comprising a composition modified barium titanate, and
a second electrode,
wherein the dielectric layer is disposed between the first electrode and the second electrode.

2. The capacitor of claim 1, wherein the modified barium titanate comprises a formula of (Ba_{1-α-μ-ν}A_{μ}D_{ν}Ca_{α})[Ti_{1-x-δ-μ′-ν′}Mn_{δ}A′_{μ′}D′_{ν′}Zrₓ]_{z}O₃, wherein A=Ag or La, A′=Dy, Er, Ho, Y, Yb, or Ga; D=Nd, Pr, Sm, or Gd; D′=Nb or Mo, 0.10≦x≦0.25; 0≦μ≦00.01, 0≦μ′≦0.01, 0≦ν≦0.01, 0≦ν′≦0.01, 0≦δ≦0.01, 0.995≦z≦1, and 0≦α≦0.005.

3. The capacitor of claim 1, wherein the ceramic particle is coated with an amphiphilic agent.

4. The capacitor of claim 1, wherein the dielectric layer has a thickness in a range of 0.1 microns to 100 microns.

5. The capacitor of claim 1, wherein the dielectric layer has a relative permittivity of at least 30.

6. A capacitor comprising:
at least one dielectric layer comprising a polymer matrix and ceramic particles dispersed within the polymer matrix, wherein the polymer comprises epoxy;
wherein the dielectric layer has a relative permittivity of at least 30.

7. The capacitor of claim 6, wherein the dielectric layer comprises a thickness in a range of 0.1 microns to 100 microns.

8. The capacitor of claim 6, wherein the dielectric layer comprises a thickness in a range of 3 microns to 30 microns.

9. The capacitor of claim 6, wherein the ceramic particles make up at least 20 vol %, at least 30 vol %, at least 40 vol %, or at least 50 vol % of a total volume of the polymer matrix and the ceramic particles.

10. The capacitor of claim 6, wherein the ceramic particles make up not greater than 95 vol %, no greater than 90 vol %, or no greater than 85 vol % of a total volume of the ceramic particles and the polymer matrix.

11. The capacitor of claim 6, wherein the ceramic particles make up in a range of 20 vol % to 95 vol %, in a range of 30 vol % to 90 vol %, or in a range of 40 vol % to 85 vol % of a total volume of the ceramic particles and the polymer matrix.

12. The capacitor of claim 6, wherein the relative permittivity in a range of 50, at least 70, or even at least 110, at least 500, at least 1100, at least 2000, or at least 3000.

13. A method of forming a capacitor on a substrate comprising:
providing a mixture including a polymer precursor solution and ceramic particles, wherein a volume percent of the ceramic particles for a total volume of the polymer solution and ceramic particles is at least 20%; and
spin coating the mixture to form the dielectric layer on the substrate.

14. The method of claim 13, wherein the polymer precursor solution comprises epoxy.

15. The method of claim 13, further comprising curing the mixture to form a dielectric layer.

16. The method of claim 15, wherein curing comprises curing the mixture at a temperature in a range of 70° C. to 140° C.

17. The method of claim 13, wherein spin coating comprises dispensing the mixture on the substrate spinning at a speed in a range of 0 rpm to 500 rpm.

18. The method of claim 17, wherein spin coating further comprises spinning at a speed in a range of 1000 rpm to 6000 rpm after dispensing.

19. The method of claim 13, wherein the dielectric layer has a thickness in a range of 0.1 microns to 100 microns.

20. The method of claim 13, wherein the dielectric layer has a relative permittivity of at least 30, at least 50, at least 70, or even at least 110, at least 500, at least 1100, at least 2000, or at least 3000.
